(19) United States
(12) Patent Application Publication
(10) Pub. No.: US 2004/0230332 A1
(43) Pub. Date: Nov. 18, 2004

(54) Blue tooth facility for transmitting stereophonic sounds

(76) Inventor: Chung Yuan Cheng, Hsin Chuang City (TW)

Correspondence Address: Chung Yuan Cheng, P. O. Box 4-67, Hsin Chuang, Taipei, 242, TW

(21) Appl. No.: 10/440,797

(22) Filed: May 17, 2003

(51) Int. Cl. H04H 5/00; G06F 17/00

(52) U.S. Cl. 700/94; 381/2

(57) ABSTRACT

A blue tooth facility includes a signal transmitting device having a sound transforming circuit to convert analog sound signals into digital signals, a converting circuit to receive and to convert the digital signals into blue tooth signals and to send out the blue tooth signals via an antenna. A signal receiving device includes another converting circuit to receive the blue tooth signals from the signal transmitting device, and to convert the blue tooth signals into digital signals, and another sound transforming circuit to receive and to transform the digital signals into stereophonic sound signals, and to send the stereophonic sound signals to the output devices.

### BACKGROUND OF THE INVENTION

1. Field of the Invention

The present invention relates to a blue tooth facility, and more particularly to a blue tooth facility capable of receiving and transmitting stereophonic sounds.

2. Description of the Prior Art

Various kinds of network systems, particularly the wireless network systems have become more and more popular nowadays. The end users are normally communicated with the network systems or the wireless network systems with package information signals, which belongs to digital signals.

For example, the typical blue tooth facilities or other wireless receiving and/or transmitting devices have now been developed to allow the end users to be communicated with the wireless network systems with the digital package information signals, but may not be communicated with each other with analog signals.

The sound signals are normally belongs to analog signals, which are different from the digital package information signals, such that the analog sound signals may not be easily and quickly received and/or transmitted with the typical blue tooth facilities, and such that the analog sound signals may be transmitted slowly between the end users and the wireless network systems with the blue tooth facilities. The stereophonic sounds thus may not be transmitted between the end users and the wireless network systems.

The present invention has arisen to mitigate and/or obviate the afore-described disadvantages of the conventional blue tooth facilities.

### SUMMARY OF THE INVENTION

The primary objective of the present invention is to provide a blue tooth facility capable of receiving and transmitting stereophonic sound signals.

In accordance with one aspect of the invention, there is provided a blue tooth facility comprising a sound device to provide analog sound signals, a signal transmitting device including a first sound transforming circuit coupled to the sound device, to receive the analog sound signals from the sound device, and to convert the analog sound signals into digital signals, a first converting circuit to receive the digital signals from the first sound transforming circuit and to convert the digital signals into blue tooth signals, and a first antenna member coupled to the first converting circuit to receive the blue tooth signals, and to transmit the blue tooth signals out of the signal transmitting device, and an output device, and a signal receiving device including a second antenna member to receive the blue tooth signals from the signal transmitting device, a second converting circuit coupled to the second antenna, to receive the blue tooth signals from the second antenna and to convert the blue tooth signals into the digital signals, and a second sound transforming circuit to receive the digital signals from the second converting circuit, and to transform the digital signals into stereophonic sound signals, and to send the stereophonic sound signals to the output device. The stereophonic sound signals may thus be received and transmitted or communicated between the end users and the wireless network systems.

The signal transmitting device includes a processor device coupled between the first converting circuit and the first sound transforming circuit and to process the digital signals from the first sound transforming circuit.

The signal receiving device includes a processor device coupled between the second converting circuit and the second sound transforming circuit and to process the digital signals from the second sound transforming circuit.

The signal receiving device includes an amplify circuit coupled between the second sound transforming circuit and the output device, to receive and to amplify the stereophonic sound signals from the second sound transforming circuit, and to send amplified stereophonic sound signals to the output device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a blue tooth facility in accordance with the present invention;

FIG. 2 is a plan schematic view of a signal transmitting device for the blue tooth facility; and

FIG. 3 is a plan schematic view of a signal receiving device for the blue tooth facility.

### DETAILED DESCRIPTION OF THE PREFERRED EMBODIMENT

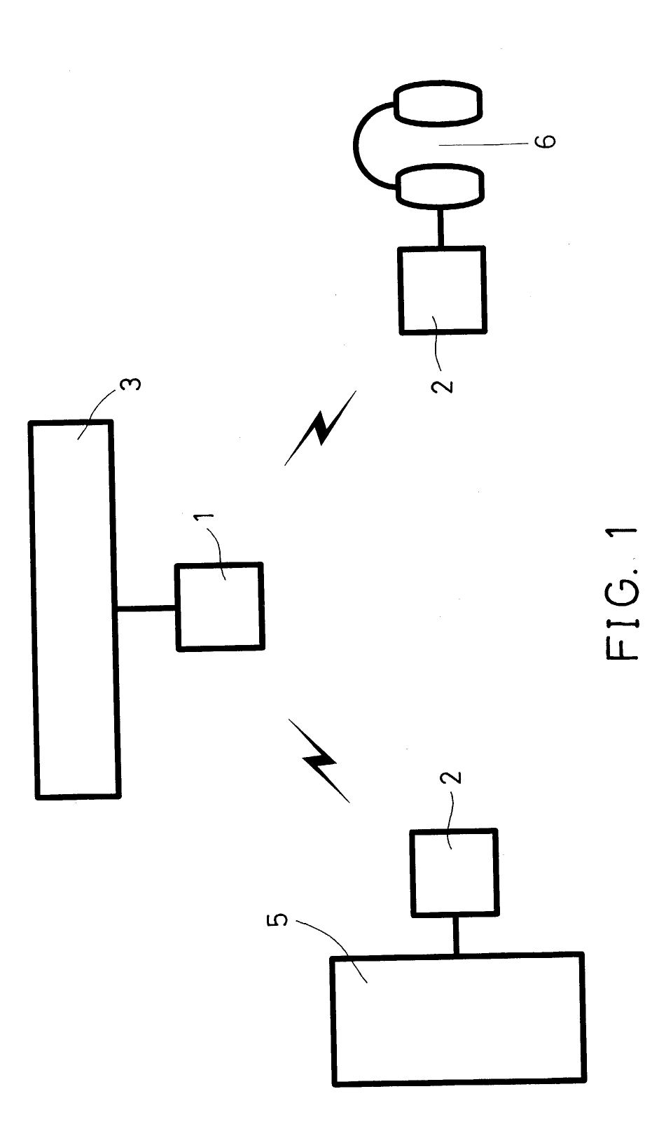

Referring to the drawings, and initially to FIG. 1, a blue tooth facility in accordance with the present invention comprises, a signal transmitting device 1 for attaching or coupling to sound devices 3, such as radio facilities, recorder facilities, televisions, etc., to receive the sounds or sound signals from the sound devices 3, and to transmit the sounds or sound signals out of the sound devices 3.

The blue tooth facility further comprises a signal receiving device 2 to receive the sounds or sound signals from the sound devices 3, and coupled to an output device 5, 6, such as speakers 5, ear pieces 6, etc., for outputting the sounds or sound signals, such as the stereophonic sounds through the output devices 5, 6.

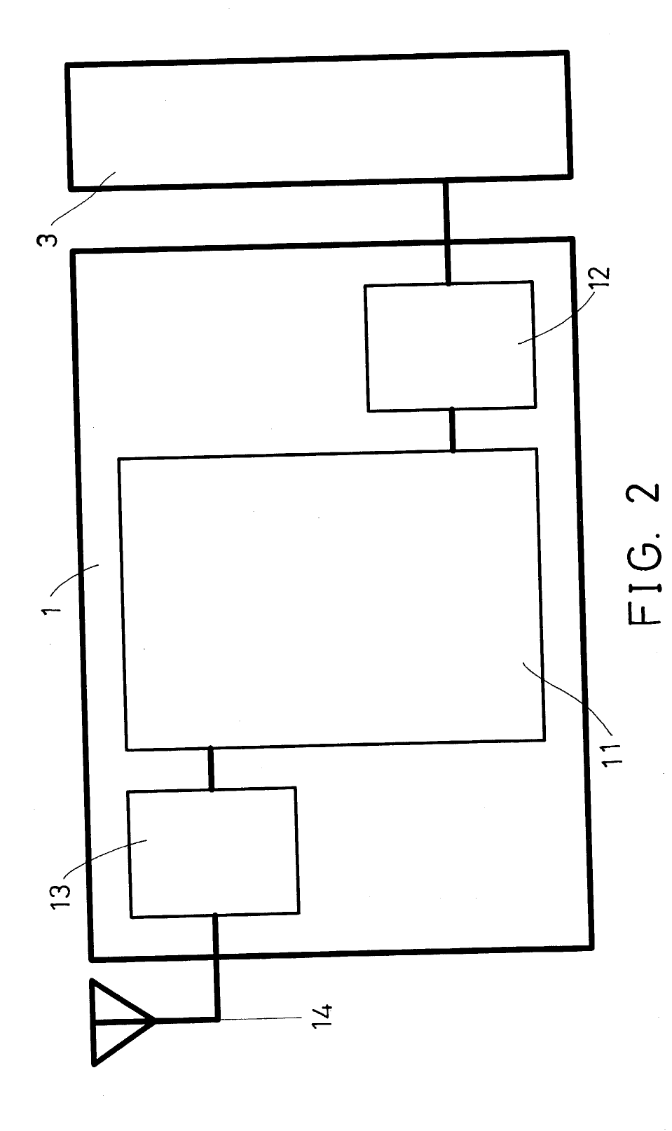

Referring next to FIG. 2, the signal transmitting device 1 includes a microprocessor or central processing unit or processor device 11, and a sound transforming and/or condensing circuit or sound transforming circuit 12 coupled between the processor device 11 and the sound devices 3.

For example, the sound transforming and/or condensing circuit 12 may be used to receive the sound or analog signals from the sound devices 3, and to convert and/or transform and/or to condense the sound or analog signals into the package or digital signals that may be easily communicated with the blue tooth facilities, and then to transmit the package or digital signals to the processor device 11.

The processor device 11 is provided to receive and to process the package or digital signals from the sound transforming and/or condensing circuit 12, and is coupled to an antenna member 14 via a converting circuit 13, for allowing the signals to be transmitted out through or via the antenna member 14.

For example, the converting circuit 13 may be used to receive the package or digital signals from the processor device 11, and to convert and/or transform the package or digital signals into the blue tooth signals that may be easily communicated with the blue tooth facilities, and then to transmit the blue tooth signals out to the signal receiving device 2 through or via the antenna member 14.

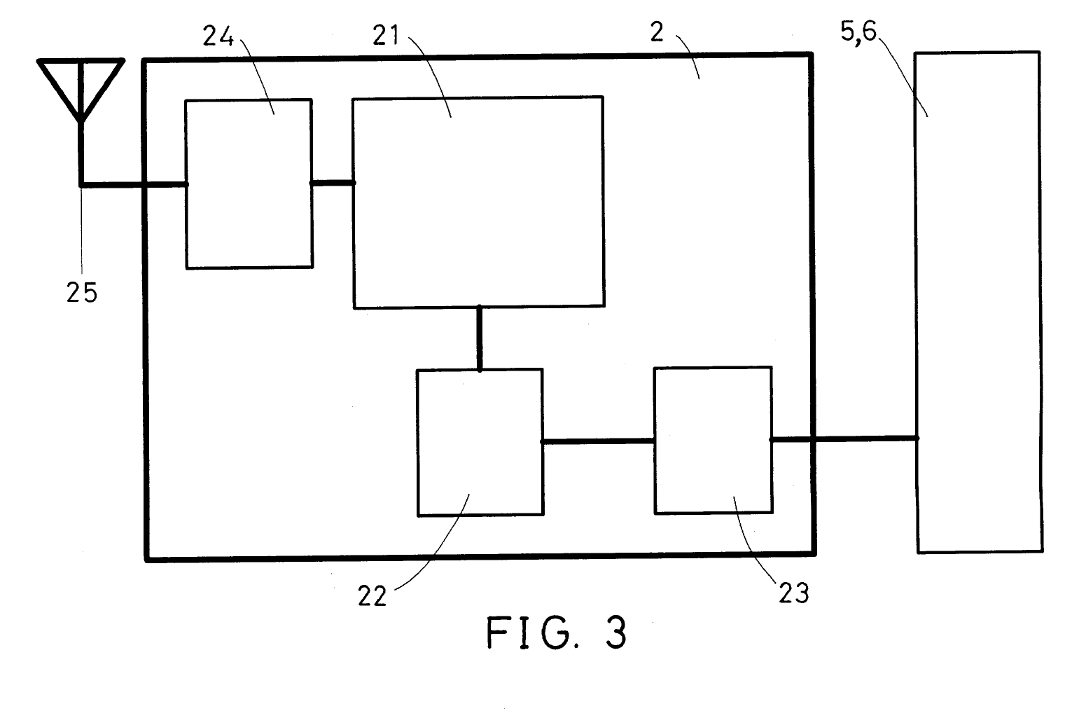

Referring next to FIG. 3, the signal receiving device 2 includes a microprocessor or central processing unit or processor device 21 coupled to either of the output devices 5, 6 via a sound transforming and/or condensing circuit or sound transforming circuit 22 and/or an amplifying circuit 23, and coupled to an antenna member 25 via a converting circuit 24.

The converting circuit 24 may be provided to receive the blue tooth signals from the converting circuit 13 of the signal transmitting device 1 with or via the antenna member 25, and to convert and/or transform the blue tooth signals into the package or digital signals, and then to send the package or digital signals to the processor device 21.

The processor device 21 may then receive and process the package or digital signals from the converting circuit 24, and may then send the package or digital signals to the sound transforming and/or condensing circuit 22.

The sound transforming and/or condensing circuit 22 may then decompress or restore or transform the package or digital signals into the stereophonic sound signals, which will then be amplified by the amplifying circuit 23, and then sent to the output devices 5, 6, for allowing the stereophonic sound to be heard by the users.

Accordingly, the blue tooth facility in accordance with the present invention may be used to receive and transmit stereophonic sound signals between the end users and the wireless network systems.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A blue tooth facility comprising:
a) a sound device to provide analog sound signals,
b) a signal transmitting device including:
i) a first sound transforming circuit coupled to said sound device, to receive the analog sound signals from said sound device, and to convert the analog sound signals into digital signals,
ii) a first converting circuit to receive the digital signals from said first sound transforming circuit and to convert the digital signals into blue tooth signals, and
iii) a first antenna member coupled to said first converting circuit to receive the blue tooth signals, and to transmit the blue tooth signals out of said signal transmitting device, and
c) an output device, and
d) a signal receiving device including:
i) a second antenna member to receive the blue tooth signals from said signal transmitting device,
ii) a second converting circuit coupled to said second antenna, to receive the blue tooth signals from said second antenna and to convert the blue tooth signals into the digital signals, and
iii) a second sound transforming circuit to receive the digital signals from said second converting circuit, and to transform the digital signals into stereophonic sound signals, and to send the stereophonic sound signals to said output device.

2. The blue tooth facility as claimed in claim 1, wherein said signal transmitting device includes a processor device coupled between said first converting circuit and said first sound transforming circuit and to process the digital signals from said first sound transforming circuit.

3. The blue tooth facility as claimed in claim 1, wherein said signal receiving device includes a processor device coupled between said second converting circuit and said second sound transforming circuit and to process the digital signals from said second sound transforming circuit.

4. The blue tooth facility as claimed in claim 1, wherein said signal receiving device includes an amplify circuit coupled between said second sound transforming circuit and said output device, to receive and to amplify the stereophonic sound signals from said second sound transforming circuit, and to send amplified stereophonic sound signals to said output device.
